(19) United States
(12) Patent Application Publication
(10) Pub. No.: US 2004/0117112 A1
(43) Pub. Date: Jun. 17, 2004

(54) Point service utilizing system, method of utilizing point service, and navigation apparatus

(76) Inventors: Takayuki Ogino, Iwaki-city (JP); Satoshi Kodama, Iwaki-city (JP); Takuji Kimura, Iwanai-gun (JP)

Correspondence Address: Brinks Hofer Gilson & Lione, NBC Tower, Suite 3600, 455 North Cityfront Plaza, Chicago, IL, 60611, US

(21) Appl. No.: 10/655,484

(22) Filed: Sep. 4, 2003

(30) Foreign Application Priority Data
Sep. 6, 2002 (JP) 2002-260707

(51) Int. Cl. G01C 21/34

(52) U.S. Cl. 701/209; 701/211; 340/995.19

(57) ABSTRACT

A point service utilizing system, a method of utilizing a point service, and a navigation apparatus are provided that enable obtaining the point service effectively in the usage of a vehicle.

An information center, when searching for facilities that offer point services corresponding to the cumulative number of points obtained, reads the cumulative number of points obtained by a user based on the user's membership information included in a search request transmitted from a vehicle, and then searches for facilities the point services of which are available to the user according to this cumulative number of points. This search result is transmitted to and displayed in a navigation apparatus mounted in the vehicle. The navigation apparatus can perform detailed display processing of a facility included in the search result, route search processing with this facility set as a destination, and route guidance.

### BACKGROUND OF THE INVENTION

1. Field of the Invention

The present invention relates to a point service utilizing system that searches for a facility capable of offering a point service and for a guidance route to the facility obtained by the facility search, a method of utilizing the point service, and a navigation apparatus therefor.

2. Description of the Prior Art

Conventionally, there are various services to provide customers with predetermined scores (points) corresponding to a purchase price of merchandise and the like so as to attract the customers. A user or the customer can obtain services such as a discount of the purchase price of merchandise, or an equivalent exchange of goods for the points, according to his/her own cumulative number of points. For example, assuming that points for use in a plurality of stores such as a restaurant, a retail shop, or the like are provided to a user, the user goes directly to the stores where his/her own points can be used considering his/her present cumulative number of points, so that the user can obtain services specific to those store.

In such a conventional service supply system as described above, it is necessary for a user to constantly grasp his/her own cumulative or accumulated number of points and stores that offer predetermined services corresponding to the points. For example, when a user intends to obtain some services from nearby stores by making effective use of his/her own cumulative number of points in driving his/her vehicle, the user must check before driving the vehicle whether there are any stores around a destination or a target area to be traveled that offer services corresponding to the points, which type of contents a service acceptable by the present point total will have, or the like. Thus, the usage of the vehicle within a wide travel area and the supply of point service are independently carried out, so that the user disadvantageously fails to obtain the point service effective in the usage of the vehicle.

### SUMMARY OF THE INVENTION

The present invention has been accomplished in view of the above-mentioned technical background, and it is an object of the present invention to provide a point service utilizing system that allows obtaining a point service effectively in the usage of a vehicle, a method of utilizing the point service, and a navigation apparatus therefor.

To solve the above-mentioned problems, according to the present invention, there is provided a point service utilizing system comprising point managing means for managing the cumulative number of points owned by each user, point reading means that, when a user is specified, is adapted to read the cumulative number of points corresponding to the specified user, facility search means for searching for a nearby available facility based on the cumulative number of points read by the point reading means, and search result displaying means for displaying the facility identified by the search of the facility search means. This enables a user to ascertain a nearby available facility according to his/her own cumulative number of points, thereby effectively obtaining a point service without taking any trouble to examine facilities which supply the cumulative points and any other point services.

The above-mentioned search result displaying means preferably displays detailed information about the facility when a predetermined operation is executed by a user. This facilitates selection of a facility as desired by the user from among the nearby available facilities.

Preferably, the above detailed information about the facility displayed includes the contents of the point service to be offered by the facility. The contents of detailed displayed information which include the specific contents of the point service facilitate the selection of the facility by the user.

More preferably, the above displayed detailed information about the facility includes the contents of a point service which is offered by the facility and which are available to a user within a range of the cumulative number of points owned by the user. When there is a plurality of point services supplied by each facility, only the contents of the point service available to the user within his/her own cumulative number of points is included in the displayed detailed information. This saves the effort of excluding the point services unavailable to the user at that time, thereby facilitating the determination in selecting the facility.

Preferably, the point service utilizing system further comprises destination setting means for selecting and setting a destination for route search processing from among a plurality of the facilities displayed by the above search result displaying means, and route search means for searching for a guidance route for the vehicle to travel to the destination set by the destination setting means. This enables the user to know a route to the facility which can offer the point service, thereby allowing the user to judge the utility of the point service in a vehicle and the like, and then to effectively accept or obtain the point service in using the vehicle.

More preferably, the point service utilizing system further comprises route guidance means for guiding a vehicle along the guidance route searched for by the above route search means. Thus, the user's driving of the vehicle along the guidance route permits the user to reach the available facility according to his/her cumulative number of points, so that he/she can obtain the point service more effectively in the usage of vehicle.

The point service utilizing system may further comprise driving state detecting means for detecting a driving state of the vehicle performed by a user, and the point managing means carries out addition processing of points corresponding to the vehicle driving state detected by the driving state detecting means to the cumulative number of points. This can provide the user with a new service which combines the driving of the vehicle and the acquisition of points.

The above-mentioned driving state detecting means may detect the driving state of the vehicle of interest by considering a relation between the vehicle of interest and another vehicle associated with the traveling of the vehicle of interest. This enables addition processing of points by considering the relation between the traveling vehicles.

If a driver of the vehicle of interest gives way to a driver of another vehicle when the other vehicle is going to enter a road or lane where it is traveling, the above-mentioned point managing means preferably carries out addition processing of points to the cumulative number of points. If a driver of the vehicle of interest gives a higher priority to the travel movement of another vehicle when a future traveling movement of the vehicle of interest is identical to that of the other vehicle, the above-mentioned point managing means preferably carries out addition processing of points to the cumulative number of points. This will foster considerate driving toward other traveling vehicles by giving a higher priority to the travel of the other vehicles. For example, a user (or a driver) who desires to obtain points gives way to another vehicle at the junction of lanes. As a result, traffic flow smoothness and reduction in vehicle accidents will be provided.

According to the present invention, there is provided a method of utilizing a point service, comprising: when a user is specified, obtaining the cumulative number of points corresponding to the specified user; searching for an available facility based on said cumulative number of points; and displaying the facility identified by the search. This enables a user to ascertain a nearby available facility according to his/her own cumulative number of points, thereby effectively obtaining the point service without taking the effort to examine facilities which supply cumulative points and any other point services.

The method may further comprise displaying detailed information on the facility identified by the search when a predetermined operation is executed by a user. This facilitates selection of a facility as desired by the user from among the available facilities.

The above detailed information on the facility preferably includes the contents of a point service to be offered by the facility. The contents of detailed displayed information, which include the specific contents of the point service, facilitate the selection of the facility by the user.

Preferably, the utilizing method further comprises: selecting and setting a destination for route search processing from among a plurality of the facilities identified by the search; and searching for a guidance route for the vehicle to travel to the destination. This enables the user to know a route to the facility available to the user which offers the point service, thereby allowing the user to judge the utility of the point service in a vehicle and the like, and then to effectively accept or obtain the point service in using the vehicle.

Preferably, the method further comprises guiding a vehicle along the guidance route. Thus, the user's driving of the vehicle along the guidance route enables the user to reach the available facility according to his/her cumulative number of points, so that he/she can obtain the point service more effectively in the usage of the vehicle.

According to the present invention, there is provided a vehicle navigation apparatus comprising the point reading means, the facility search means, and the search result displaying means, all of which have been described above. This enables the user of the navigation apparatus to ascertain a nearby available facility according to his/her own cumulative number of points, thereby effectively obtaining the point service without needing to examine facilities which supply cumulative points and any other point services.

According to the present invention, there is provided a vehicle navigation apparatus comprising the point reading means, the facility search means, the search result displaying means, the destination setting means, the route search means, and the route guidance means, all of which have been described above. This enables the user to know a route to the available facility which offers the point service, while the user's driving of the vehicle along the guidance route enables the user to reach the available facility according to his/her cumulative number of points, so that he/she can obtain the point service more effectively in the usage of the vehicle.

### BRIEF DESCRIPTION OF THE DRAWINGS

FIG. 1 is a diagram showing the general configuration of a point service utilizing system according to one preferred embodiment of the present invention.

FIG. 2 is a diagram showing the general configuration of a vehicle-mounted system which is mounted in a vehicle according to the preferred embodiment.

FIG. 3 is a diagram showing a detailed configuration of a navigation apparatus.

FIG. 4 is a diagram showing a detailed configuration of an information center.

FIG. 5 is an exemplary diagram showing a membership set screen into which the type and a number of a credit card owned by a user as a member are entered.

FIG. 6 is a flowchart showing the operation of the navigation apparatus.

FIG. 7 is an exemplary diagram showing a search result screen.

FIG. 8 is an exemplary diagram showing a detailed display screen.

FIG. 9 is a flowchart of an operation procedure of an information center.

FIG. 10 shows an example in which addition processing of points is carried out by detecting the driving state of a vehicle.

FIG. 11 shows the example in which the addition processing of points is carried out by detecting the driving state of the vehicle.

FIG. 12 is a flowchart showing an operation performed by the vehicle in cases where the addition processing of new points to the user's own points is carried out by detecting the vehicle driving state.

FIG. 13 is a flowchart showing an operation at an information center which receives a request for addition of points.

### DETAILED DESCRIPTION OF PREFERRED EMBODIMENTS

A point service utilizing system according to one preferred embodiment of the present invention will be described below with reference to the accompanying drawings.

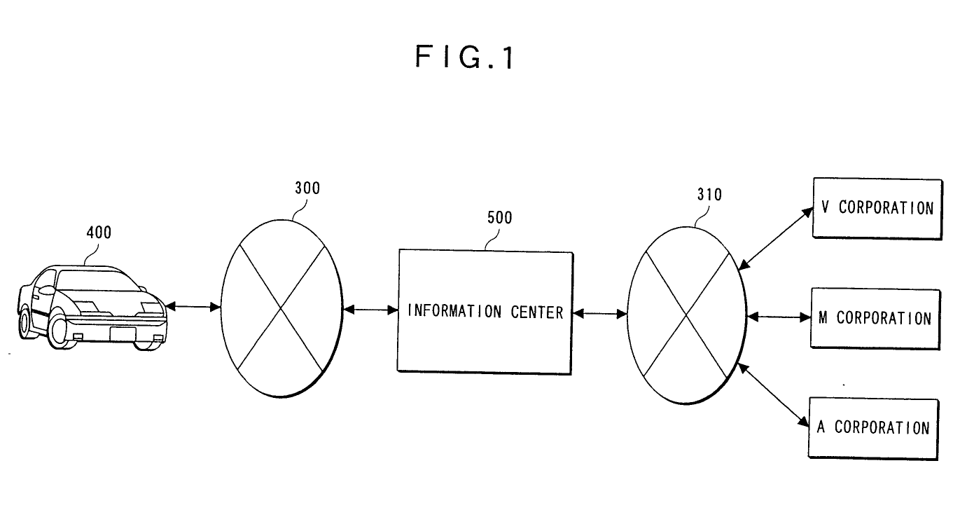

FIG. 1 shows the general configuration of the point service utilizing system according to the preferred embodiment. The point service utilizing system as shown in FIG. 1 includes a vehicle 400 in which a user of this system rides, and an information center 500 that searches for facilities to offer various kinds of services according to the cumulative number of points owned by the user (hereinafter referred to as “point services” which are various services available to the user depending on his/her own points). The vehicle 400 and the information center 500 are connected in communication with each other through a predetermined network 300. It should be noted that the network 300 of the preferred embodiment includes a mobile phone network, which connects a vehicle-mounted system (described later) mounted in the traveling vehicle 400 and the information center 500. More specifically, the vehicle-mounted system and the network 300 are connected in communication with each other through a portable telephone serving as the mobile phone and disposed in the vehicle 400.

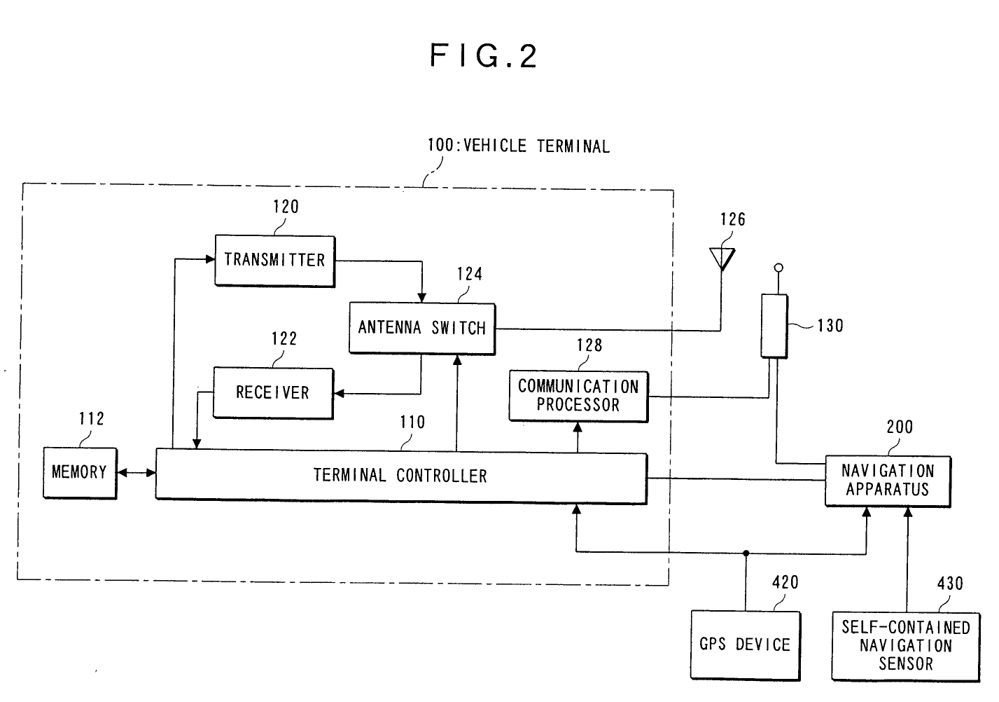

The details of the vehicle-mounted system in the vehicle 400 will be described below. FIG. 2 shows the general configuration of the vehicle-mounted system in the vehicle 400 of the preferred embodiment. It should be noted that in the preferred embodiment, all participating vehicles install vehicle-mounted systems of the same configuration.

As shown in FIG. 2, the vehicle-mounted system in the vehicle 400 may include a vehicle terminal 100, a navigation apparatus 200, a GPS (global positioning system) device 420, and a self-contained navigation sensor 430.

The vehicle terminal 100 transmits and receives various kinds of data between vehicles by carrying out inter-vehicle communications with a vehicle terminal 100 mounted in another vehicle. For this, the vehicle terminal 100 includes a terminal controller 110, a memory 112, a transmitter 120, a receiver 122, an antenna switch 124, an antenna 126, and a communication processor 128.

The terminal controller 110 controls the entire operation of the vehicle terminal 100 by executing a predetermined operation program stored in the memory 112. In addition to this operation program executed by the terminal controller 110, the memory 112 stores a native ID assigned to the vehicle terminal 100, vehicle information on the type of vehicle 400 in which the vehicle terminal 100 is mounted, and user information. Further, the memory 112 stores membership information when the user has membership in a point service offered by a credit card and the like.

The transmitter 120 transmits a transmission signal produced from the terminal controller 110 from the antenna 126 to another vehicle through the antenna switch 124. The receiver 122 receives a reception signal transmitted from another vehicle and reaching the antenna 126 through the antenna switch 124. The antenna switch 124 selectively connects the antenna 126 to one of the transmitter 120 and the receiver 122 based on a transmission and reception switching signal from the terminal controller 110.

The communication processor 128 transmits a predetermined notice (described later) produced by the terminal controller 110 from an external portable telephone 130 connected to the vehicle terminal 110 to the information center 500 through the network 300.

The navigation apparatus 200 performs normal navigation operations including displaying a map image covering a traveling position of the vehicle 400 and its surroundings, searching for a guidance route for traveling to a predetermined destination, and guiding the vehicle 400 based on the guidance route. In addition to these operations, the navigation apparatus 200, when the user (or the driver) has membership in any point services offered by a credit card and the like, performs a facility search operation, that is, searches for available facilities which offer any point services available to the user within the cumulative number of points corresponding to him/her.

This navigation apparatus 200 is connected to the GPS device 420 and the self-contained navigation sensor 430. These devices may be disposed in a casing of the navigation apparatus 200. That is, these are not necessarily connected to the external portion of the casing. The GPS device 420 includes a GPS antenna and a calculation section for analyzing radio waves received by the GPS antenna from a satellite, and provides the position (longitude and latitude) of the vehicle 400. The positional information on the vehicle 400 produced from the GPS device 420 is also transmitted to the vehicle terminal 100. The self-contained navigation sensor 430 includes a distance sensor and a direction sensor (gyro). Based on sensor outputs from them, the navigation apparatus 200 calculates the position of the vehicle 400.

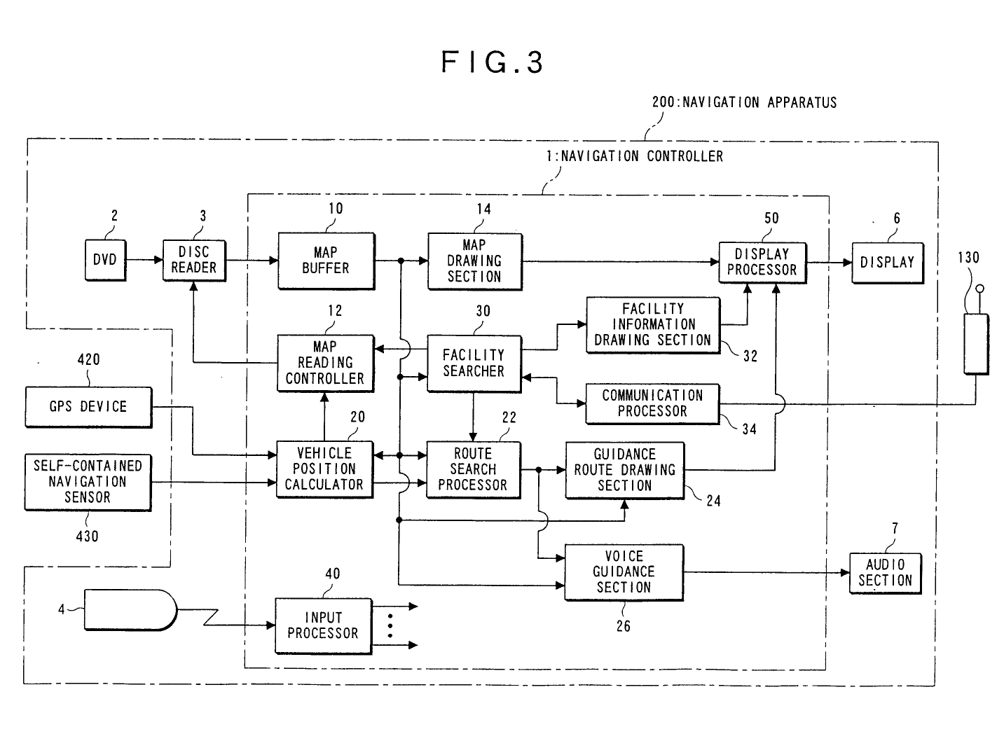

FIG. 3 shows the detailed configuration of the navigation apparatus 200. The navigation apparatus 200 as shown in FIG. 2 includes a navigation controller 1, a DVD 2, a disc reader 3, a remote control unit (remote controller) 4, a display 6, and an audio section 7.

The navigation controller 1 controls the entire navigation apparatus. This navigation controller 1 executes predetermined operation programs using a CPU, a ROM, a RAM and the like to perform its predetermined function.

The DVD 2 is an information recording medium storing map data necessary to perform various kinds of navigation processing such as a map display operation, a route search operation, or the like. The map data includes map image data required for the display of the map and road data required for the route search. This DVD 2 stores the map data in units of rectangular map pieces each of which is separated by given longitudinal and latitude lines to have an appropriate size. Each map piece of the map data is specified by designating a number of the map piece to be read out.

The disc reader 3 is capable of having one or more DVDs 2 loaded thereon and reads the map data from any one of DVDs 2 under control of the navigation controller 1. The loaded disc may not be necessarily a DVD, but can be a CD or the like. Further, the disc reader may selectively load the DVD or the CD.

The remote control unit 4 has various types of operating keys including a joy stick to designate the longitudinal and latitudinal directions, a ten-digit keypad to enter numerals, a determination key to fix various settings, and the like. The remote control unit 4 transmits a signal responsive to the operation contents to the navigation controller 1. In this embodiment, search conditions are designated when making a request for a search to the information center 500, and membership information is pre-entered when the user has membership in a credit card or the like. These operations are carried out with the remote control unit 4.

The display 6 is adapted to display various types of images such as a map image covering the present vehicle position and its surroundings, a result of searching through neighboring facilities, or the like, based on drawing data received from the navigation controller 1. The audio section 7 generates in the vehicle a guidance voice generated on the basis of a voice signal received from the navigation controller 1.

As shown in FIG. 3, the above-mentioned navigation controller 1 includes a map buffer 10, a map reading controller 12, a map drawing section 14, a vehicle position calculator 20, a route search processor 22, a guidance route drawing section 24, a voice guidance section 26, a facility searcher 30, a facility information drawing section 32, a communication processor 34, an input processor 40, and a display processor 50.

The map buffer 10 temporarily stores the map data read from the DVD 2 by the disc reader 3. The map reading controller 12 provides a request for reading the map data of a predetermined area to the disc reader 3, according to the vehicle position calculated by the vehicle position calculator 20 and an instruction from the input processor 40. The map drawing section 14 performs drawing processing necessary to display the map image to generate the map image drawing data, based on the map data stored in the map buffer 10.

The vehicle position calculator 20 calculates the present position of the vehicle 400 based on data received from the GPS device 420 and the self-contained navigation sensor 430. Further, the calculator 20 performs a map matching procedure for amending or revising the vehicle position based on the shapes of roads and traveling tracks in a map when the calculated position of the vehicle is not located on an actual road of the map.

The route search processor 22 searches for a traveling route connecting a starting point and a destination, based on a predetermined search condition, as a guidance route. The guidance route drawing section 24 generates guidance route drawing data for displaying the guidance route obtained by the search processing of the route search processor 22 superimposed on the map. The voice guidance section 26 generates voice signals such as intersection guidance and the like needed to guide the vehicle along the guidance route obtained by the search processing of the route search processor 22.

The facility searcher 30, when facilities to satisfy the search condition specified by the user are searched for by the information center 500 and then the search result thereof is transmitted, selects one from among the facilities. The facility information drawing section 32 performs the drawing processing necessary to display the transmitted search result and detailed information on the selected facility, to generate facility information drawing data.

The communication processor 34 performs the processing needed to carry out various types of data communications of search conditions, search results, or the like between the navigation apparatus 200 and the information center 500 through the network 300. The portable telephone 130 is externally attached to this communication processor 34.

The input processor 40 provides to respective components of the navigation controller 1 the commands for executing operations corresponding to various operating instructions received from the remote control unit 4. The display processor 50, which receives the map image drawing data generated by the map drawing section 14, displays the map image of the predetermined area on a screen of the display 6 based on this drawing data. When the facility information drawing data generated by the facility information drawing section 32 and the guidance route drawing data generated by the guidance route drawing section 24 is provided, the display processor 50 displays the drawing data superimposed on the map image on the screen of the display 6.

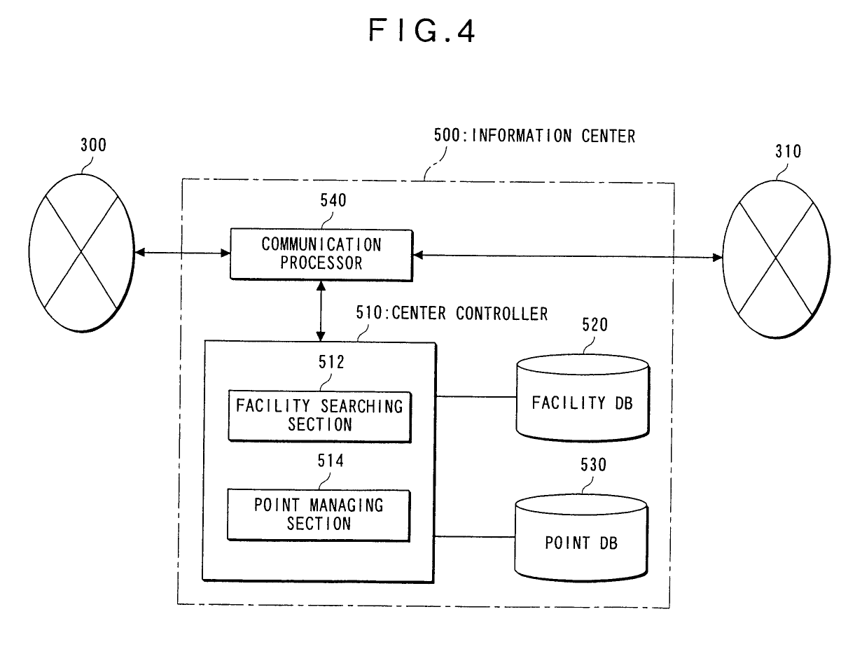

Now, the detailed configuration of the information center 500 will be described below. FIG. 4 shows the detailed configuration of the information center 500. The information center 500, as shown in FIG. 4, includes a center controller 510, a facility DB (database) 520, a point DB 530, and a communication processor 540.

The center controller 510 controls the entire information center 500 so as to search for a predetermined facility requested by the navigation apparatus 200 and to return a search result to the navigation apparatus. The controller 510 includes a facility searching section 512 and a point managing section 514. The center controller 510 has a computer comprising a CPU, a ROM, a RAM, and the like. By executing a predetermined program stored in the ROM or RAM, it carries out a predetermined control operation.

The facility searching section 512 searches for facilities to satisfy the search condition transmitted from the navigation apparatus 200. The point managing section 514, when a user has membership in a credit card or the like and a point service is being supplied to all the membership, manages and updates the cumulative number of points owned by each user.

The facility DB 520 stores detailed facility information which is necessary for a facility search. This facility information includes the contents of a point service offered by each facility, in addition to a facility name, a category of the facility, an address and a telephone number thereof. For example, when one facility offers an exchange service of goods according to the user's points, or when the other facility offers a discount service on goods according to the user's points, information on these services is stored in the facility DB.

The point DB 530 stores the latest cumulative number of points owned by each user. When one user has membership in a plurality of groups, he/she can selectively utilize a plurality of point services corresponding to the respective groups. In this case, a plurality of combinations, each including the user's membership name and his/her cumulative number of points, is stored in the DB.

The communication processor 540 performs processing so that the information center 500 may carry out data communications with the vehicle 400 through the network 300.

Now, assuming that a user has membership in a credit card, the cumulative number of points owned by the user is changed or altered when the credit card is used or when the credit card is invalid. Thus, the cumulative number of points stored in the point DB 530 for each user should be constantly updated. In this embodiment, as shown in FIG. 1, the information center 500 and a credit card company (for example, V Corporation, M Corporation, A Corporation, or the like) are connected to each other through a network 310 such as the Internet. Based on the latest updated information offered by each of the credit card companies, the contents stored in the point DB 530 of the information center 500 are to be updated.

The above-mentioned point managing section 514 corresponds to point managing means and point reading means; the facility searching section 512 to facility search means; and the facility information drawing section 32 and the display processor 50 to search result displaying means, respectively. The remote control unit 4, the input processor 40, and the facility searcher 30 correspond to destination setting means; the route search processor 22 to route search means; and the guidance route drawing section 24 and the voice guidance section 26 to the route guidance means, respectively. The terminal controller 110 in the vehicle terminal 100 corresponds to the driving state detecting means.

The point service utilizing system according to the preferred embodiment has the configuration as described above. Now, the operation of the point service utilizing system will be described below.

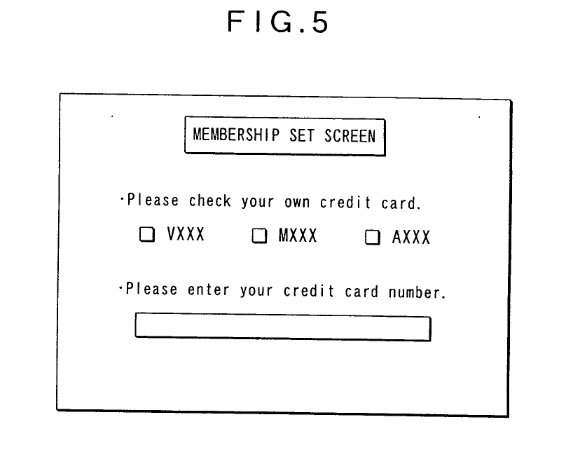

FIG. 5 shows an exemplary diagram of a membership set screen into which a type of credit card and a number thereof are entered by a user who has membership in the credit card. As shown in FIG. 5, on the upper part of the membership set screen in the preferred embodiment, there are provided a sentence “Please check your own credit card” and check items for representative credit cards such as “V XXX,” “M XXX,” “A XXX,” and the like. The user checks a check item for his/her own credit card by manipulating the remote control unit 4. (For example, the user depresses a “set key” with a desired check item selected.)

On the lower part of the membership set screen, there are provided a sentence “Please enter your credit card number” and an input frame for entering the card number. The user directly enters in this input frame a number of his/her credit card which has been designated or checked at the upper area of the screen. For example, the ten-digit keypad included in the remote control unit 4 is used to enter this card number. It should be noted that when a user has a plurality of credit cards, this entering operation will be repeatedly performed the same number of times as the number of credit cards. Although in the example of FIG. 5 the input operation of membership information about membership in the credit card has been explained in detail, any other membership information about other memberships (for example, members or the like recruited by respective department stores) to be offered any point service may be entered in the same manner.

The membership information entered from the above-mentioned membership set screen is stored in a recording device (not shown) such as a nonvolatile memory or the like in the navigation apparatus 200.

(The Operation of the Navigation Apparatus)

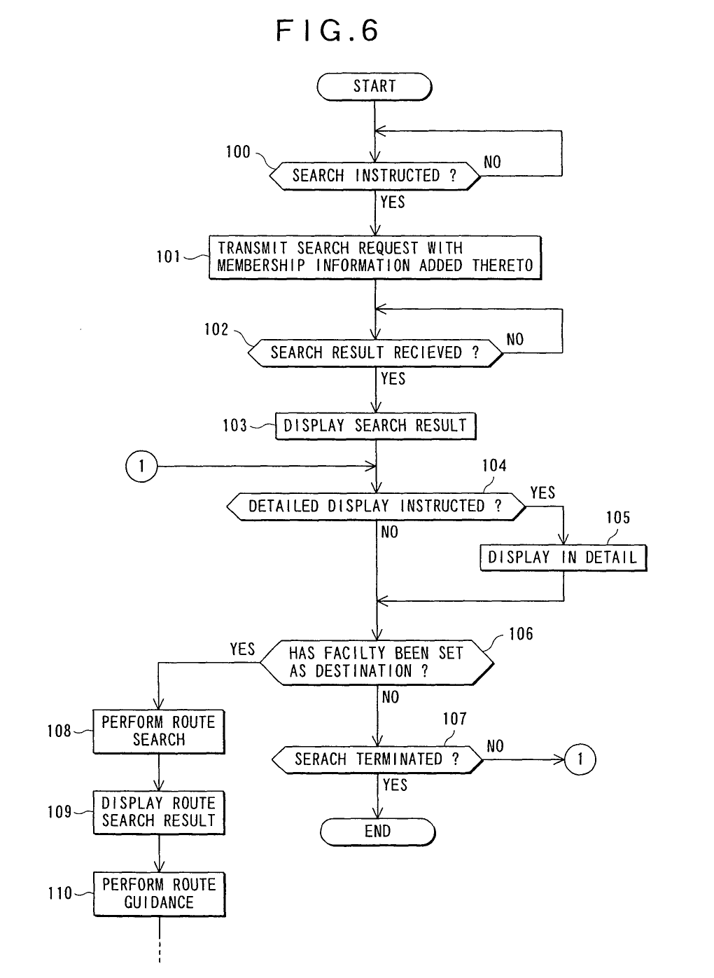

FIG. 6 is a flow chart showing the operating procedure of the navigation apparatus 200. In particular, the operation of the navigation apparatus 200 is to search for a facility offering a point service available to a user within his/her own cumulative number of points when the user has membership in a credit card or the like.

In parallel with display processing of the map image covering the present vehicle position and its surroundings, the facility searcher 30 determines whether a search instruction is provided or not (step 100). Before the search instruction is given, it continues making a negative determination. When a user manipulates the remote control unit 4 to give a predetermined search instruction, an affirmative determination is made in step 100. Next, the facility searcher 30 transmits the search instruction with membership information added thereto, which information has been obtained from the membership set screen of FIG. 5, to the information center 500 through the communication processor 34 (step 101). After this transmission processing is ended, the facility searcher 30 determines whether a search result sent from the information center 500 is received or not (step 102). If not received, it makes a negative determination and repeats this determination processing.

If the search result sent from the information center 500 is received through the communication processor 34, an affirmative determination is made in step 102. Then, the facility information drawing section 32 displays the received search result (step 103). As one example of the search result, available facilities within the user's cumulative number of points are listed in order of distance from the vehicle 400.

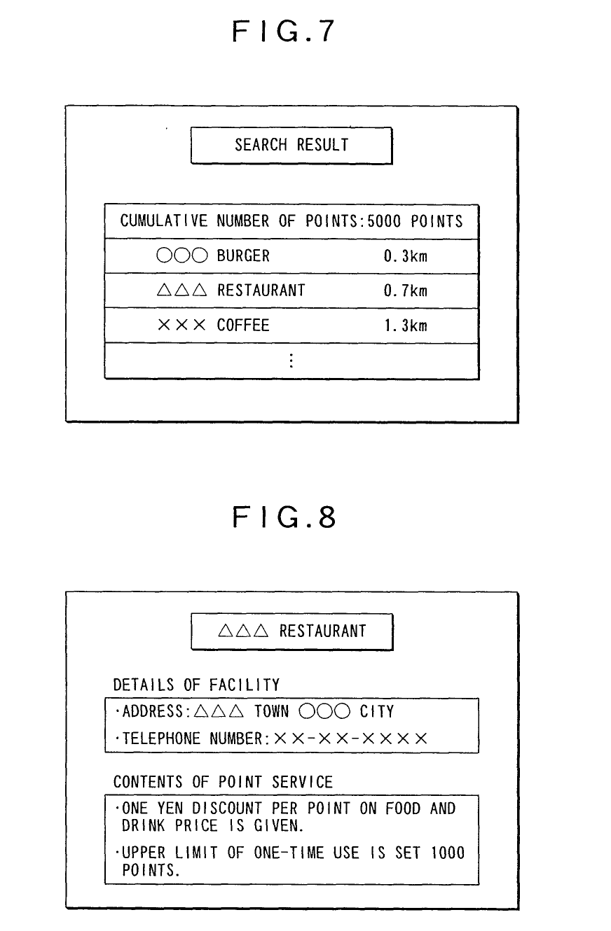

FIG. 7 shows an exemplary diagram of the search result screen. On this search result screen as shown in FIG. 7, when the user has the cumulative number of points of “5000 points,” there are displayed “∘∘∘ burger,” “□□□ restaurant,” and “XXX coffee” as the facilities available to the user within his/her own cumulative number of points in order of distance from the vehicle position. On the right side of each facility, there is provided a linear distance between the vehicle 400 and the corresponding facility. Further, when the user desires to display other facilities included in the search result, the user may manipulate the joy stick or an arrow key included in the remote control unit 4 to scroll through the display contents.

Next, the facility searcher 30 determines whether the detailed display of one facility included in the search result is instructed or not (step 104). When the user manipulates the remote control unit 4 to instruct the detailed display of a facility, the facility searcher 30 makes an affirmative determination. Then, the facility information drawing section 32 displays the detailed information on the one facility designated (step 105). For example, when a transmission request for transmitting the detailed information about the designated facility is sent to the information center 500 through the communication processor 34, this detailed information about the facility is read from the facility DB 520 to be returned to the navigation apparatus. The facility information drawing section 32 draws and displays the contents of the detailed information. This detailed information includes the exemplary contents of the point service offered by the facility, in addition to detailed contents of the facility such as an address of the facility, a telephone number thereof, or the like.

FIG. 8 shows an exemplary diagram of a detailed display screen. On the detailed display screen of FIG. 8, there are provided a frame for a name of the selected facility “ΔΔΔ restaurant,” a frame for the details of the facility “Details of Facility,” and a frame for the contents of a point service “Contents of Point Service.” For example, the frame “Details of Facility” includes an address of ΔΔΔ restaurant, a telephone number thereof, and the like, while the frame “Contents of Point Service” includes the exemplary contents thereof, that is, “One Yen Discount per Point on Food and Drink Price is Given,” and “Upper Limit of One-Time Use is Set 1000 Points.”

This “Contents of Point Service” may include only the point services available to the user within his/her cumulative number of points. This advantageously excludes point services that are unavailable at that time, thereby facilitating the selection of a facility.

After the detailed information is displayed, or after the negative determination is made in step 104 when the detailed information is not instructed to be displayed, the route search processor 22 determines whether one facility is set as a destination for a route search or not (step 106). If it is not set as the destination, a negative determination is made. Then the facility searcher 30 determines whether the search should be ended or not (step 107). If the facility search is desired to be continued, a negative determination is made in step 107, and then the operation returns to the above-mentioned step 104, so that processes following the determination process of the detailed display instruction will be continuously carried out. When the user manipulates the remote control unit 4 to give an instruction to end the search processing, an affirmative determination is made in step 107, thereby terminating the facility search processing.

On the other hand, when the user instructs the designation of a destination by manipulating the remote control unit 4 with one facility which is included in the list of the search result being selected, or with the detailed information on one facility being displayed, an affirmative determination is made in the step 106. Then the route search processor 22 searches for an appropriate guidance route for traveling from the present vehicle position as a starting point to the set destination (step 108). The guidance route obtained by this route search is superimposed on the map image by the guidance route drawing section 24 (step 109), so that route guidance is thereafter conducted by the voice guidance section 26 (step 110).

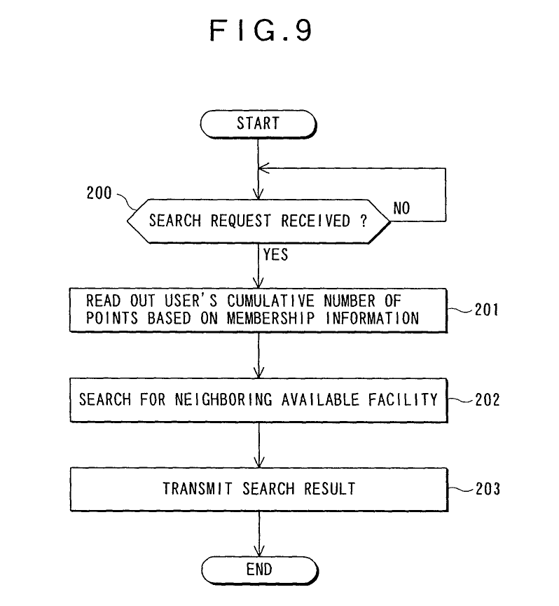

FIG. 9 shows a flowchart of the operating procedure of the information center 500. In particular, the operating procedure is to search for a facility in accordance with a search request from the navigation apparatus 200.

The facility searching section 512 determines whether a search request sent from the navigation apparatus 200 is received or not (step 200). Before the search request is given, it continues making a negative determination. After the search request is given, an affirmative determination is made in step 200. Then the point managing section 514 reads from the point DB 530 the cumulative number of points corresponding to the user who has made the search request, based on the membership information included in the search request (step 201).

Next, the facility searching section 512 searches for neighboring facilities offering point services available within the cumulative number of points, which has been read by the point managing section 514, based on the facility information stored in the facility DB 520 (step 202). For example, the facility DB 520 includes data on the minimum number of points which makes it possible to obtain a given point service for each facility. And the facility searching section 512 is designed to search through facilities except for a facility which does not provide any point service or which requires a minimum number of points larger than the user's own cumulative number of points in offering its point service.

Next, the facility searching section 512 transmits the list of facilities extracted by the search as the search result to the navigation apparatus 200 through the communication processor 540 (step 203).

As described above, in the preferred embodiment, the user can look at the available facilities in the form of a list according to his/her own cumulative number of points and quickly grasp the contents of the list. This makes it possible to effectively ascertain the point service without taking the trouble to examine facilities which supply cumulative points and any other point services.

The detailed information on each facility is displayed when displaying the search result, thereby facilitating the selection by the user of the desired one from among the available facilities. In particular, the contents of the point service offered by each facility are included in this detailed information, further facilitating the selection of the facility by the user.

Moreover, only the point services available to the user within his/her own cumulative number of points is displayed when the contents of the point services are shown in the detailed display. This saves the trouble of considering and excluding unavailable point services at that time, thus allowing for easier selection of the facility.

Further, when one facility included in the search result is set as the destination and route search processing is carried out, the vehicle can be guided along a guidance route obtained by the route search processing. This allows the user to easily know the route to the facility offering the point service, and to reach the facility available according to his/her own cumulative number of points by driving his/her vehicle based on the guidance. In using the vehicle, the user can utilize the point service more effectively.

In cases where the user has membership in a credit card, a department store, or the like, the cumulative number of points of the member is generally increased depending on the amount of use of the credit card or the like. In the preferred embodiment, an addition method of points corresponding to the driving state of the vehicle when the driving state thereof is detected may be employed instead of the aforesaid addition method of points.

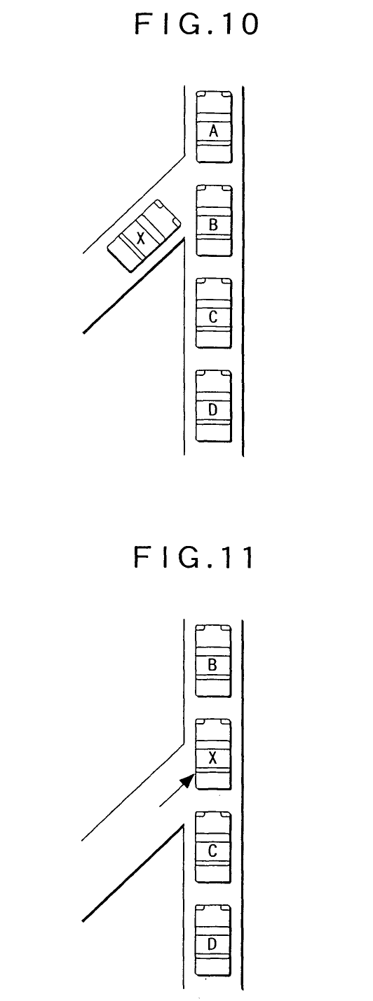

FIG. 10 and FIG. 11 are exemplary diagrams showing such an addition method of points by detecting a driving state of the vehicle, and especially show the case where one vehicle is entering a congested road. As shown in FIG. 10, the vehicle X is entering from a side road into a congested road where the vehicles A, B, C, and D are lining up. In the present embodiment, the vehicle C gives way to the vehicle X so as to let the vehicle X proceed in front of itself as shown in FIG. 11. In this case, the driver of vehicle C is given new predetermined points to his/her own cumulative number of points.

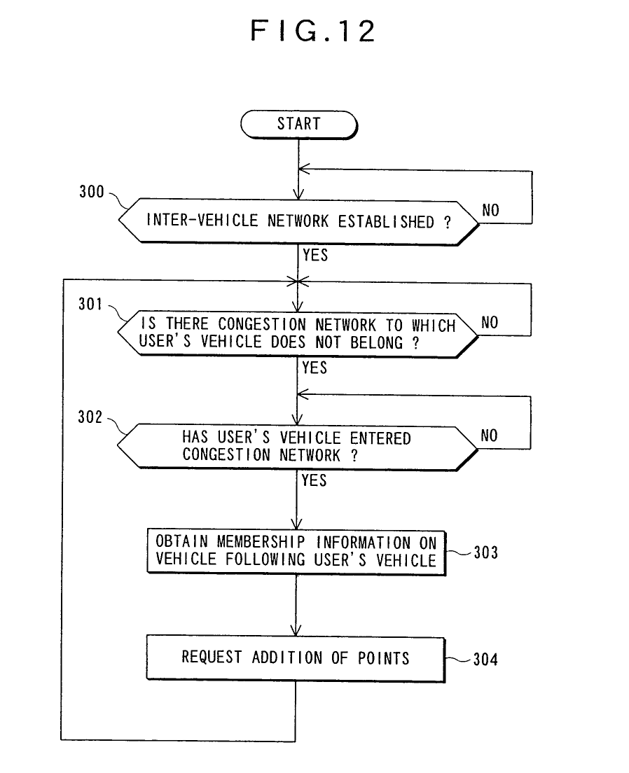

FIG. 12 is a flowchart showing the operating procedure on the vehicle side when the user's own cumulative number of points is added by detecting the driving state of the vehicle. Mainly, the figure shows the operating procedure of the vehicle terminal 100 mounted in the vehicle.

The terminal controller 10 of the vehicle terminal 100 mounted in each vehicle transmits an inquiry signal from the transmitter 120 at regular intervals, while determining whether or not an inter-vehicle network between the user's vehicle and another vehicle is established by checking a response to the inquiry signal and another inquiry signal transmitted from another vehicle by means of the receiver 12 (step 300). This inter-vehicle network is established between two or more vehicles are directly connectable to one another. Further, the network may be also established between vehicles which cannot directly transmit and receive radio waves because of the distance therebetween, but which can communicate through one or more other vehicles serving as a relay node. Thus, the inter-vehicle network can be formed in both cases including these vehicles.

If the inter-vehicle network is not established, a negative determination is made in step 300 and this determination processing is repeatedly performed. If the inter-vehicle network is established, an affirmative determination is made in step 300, and the terminal controller 110 determines whether or not there is a congestion network to which the user's vehicle does not belong (step 301). For example, the congestion network is the inter-vehicle network composed of vehicles A, B, C, D, and the like traveling on the congested road as shown in FIG. 10. (More accurately, the congestion network is composed of all vehicle terminals 100 mounted in these vehicles.) Once the inter-vehicle network is established, the vehicle terminals 100 transmit and receive the positional information on the respective vehicle positions detected by the GPS device 420, thereby enabling the determination in step 301 based on a traveling speed and a traveling position of each vehicle.

If there is no congestion network to which the user's vehicle does not belong, a negative determination is made in step 301, and this determination processing is repeatedly carried out. In contrast, if there is such a congestion network, an affirmative determination is made in step 301. Thereafter, the terminal controller 110 determines whether or not the user's vehicle is newly entering the congestion network (step 302). If not, a negative determination is made and this determination processing is repeatedly carried out. When the user's vehicle newly enters the congestion network, an affirmative determination is made in step 302. Then the terminal controller 110 obtains membership information on another driver (or another user) of another vehicle following the user's vehicle (step 303), that is, another vehicle which has given way to the user's vehicle, and requests for addition of points to the member's or the other driver's cumulative number of points from the portable telephone 130 to the information center 500 through the communication processor 128 (step 304). Thereafter, the operation returns to step 301 and the determination processing of the congestion network is repeatedly carried out.

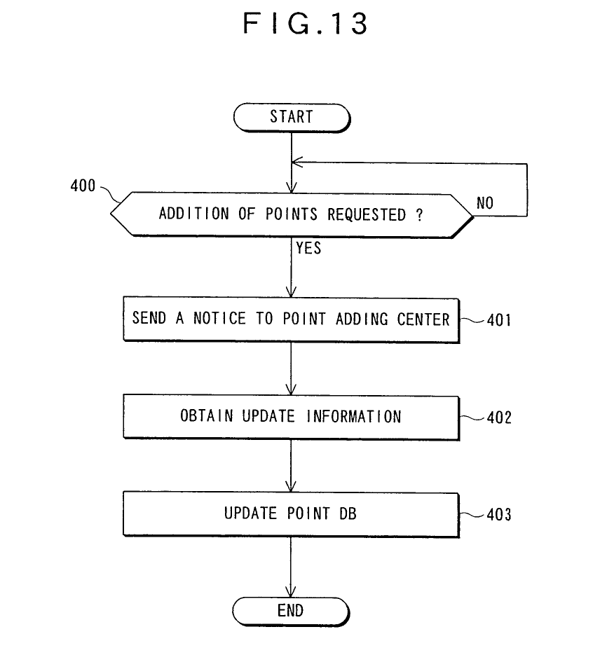

FIG. 13 shows a flowchart of the operating procedure on the information center 500 side which receives the request for addition of points.

The point managing section 514 of the center controller 510 in the information center 500 determines whether or not a request for addition of points is made from any of the vehicles (step 400). If not, a negative determination is made, and this determination processing is repeatedly carried out. If the request for addition of points is received from any one of the vehicles, an affirmative determination is made in step 400. Then, the point managing section 514 sends a predetermined notice including the point addition request to a point adding center which sums the cumulative number of points based on the membership information included in this request (step 401). Specifically, when the driver who is to be provided with the addition of new points, namely the above other driver in the described example, has membership in a credit card, a calculating center of each credit company or the like associated with the driver serves as this point adding center, and this notice is transmitted to the center through the network 310. When the point adding center receives this notice, the addition of predetermined points corresponding to the member's cumulative number of points, which are specified by the membership information, is carried out. Thereafter, the latest updated information including the latest cumulative number of points after this addition processing is sent to the information center 500.

When the point managing section 514 obtains the latest information sent from the above-mentioned point adding center (step 402), it updates the corresponding data in the point DB 530 (step 403).

As described above, to the driver's cumulative number of points are added new points according to the driving state of the vehicle, whereby a new service combining the driving of the vehicle and acquisition of points can be provided. In detecting the driving state of the vehicle of interest, the detection is carried out considering a relation between the vehicle of interest and another vehicle associated with this traveling vehicle of interest. (In the example of FIG. 10 and FIG. 11, the driving state of the vehicle C of interest is detected considering a relation between the vehicle C and the vehicle X.) Accordingly, the addition of points can be provided considering the relation between the traveling vehicles.

Particularly, assuming that there is another vehicle that is entering a road or a lane where the vehicle of interest is traveling, when a driver of the vehicle of interest gives way to a driver of another vehicle, new points are preferably added to the cumulative number of points owned by the driver of the vehicle of interest. In short, if the driver of the vehicle of interest gives a high priority to the traveling movement of another vehicle when a future traveling movement of the vehicle of interest is identical to that of another vehicle, there is preferably provided the addition processing of new points to the cumulative number of points. This will provide an incentive for a user (or driver) who desires to obtain new points to drive considerately, for example, to give a high priority to the traveling movement of the other vehicles, more specifically, to give way to another vehicle at the junction of lanes. As a result, traffic flow smoothness and reduction in vehicle accidents can be provided.

The present invention is not limited to the specific embodiments disclosed, and modifications and other embodiments are intended to be included within the scope of the invention. In the above embodiment, the facility search processing is carried out in the information center 500, but may be performed in the navigation apparatus 200. In this case, the function of the center controller 510 in the information center 500 is performed by the navigation controller 1 (for example, a facility searcher 30) of the navigation apparatus 200 instead of the controller. Also, various kinds of information stored in the facility DB 520 and the point DB 530 are stored in the DVD 2. Then, if necessary, the information may be transmitted to the map buffer 10. It should be noted that the cumulative number of points owned by each user and stored in the point DB 530 may be set by obtaining the latest update information from the adding center or the like for summing the cumulative number of points.

In the above-mentioned embodiment, as one example of the addition processing of new points to the user's cumulative number of points depending on the driving state of the vehicle, the case where another vehicle is entering a congested road with the vehicles has been explained. The present invention is not limited to this case, and in other cases addition processing of new points may be performed insofar as one traveling vehicle gives way to another vehicle. For example, when the vehicle of interest gives way to another vehicle which is traveling in the next lane while operating direction indicators, so as to let this other vehicle change lanes in front of itself, new points may be added to the cumulative number of points owned by the user of the vehicle of interest.

As can be seen from the above, the present invention enables the user to ascertain an available facility according to his/her own cumulative number of points, thereby effectively obtaining the point service without taking the trouble to examine unavailable facilities which supply cumulative points and any other point services.

What is claimed is:

1. A point service utilizing system comprising:
a point managing section for managing the cumulative number of points owned by each user;
a point reader that when a user is specified, is adapted to read said cumulative number of points corresponding to the specified user;
a facility search section for searching for an available facility based on said cumulative number of points read by said point reader; and
a search result displaying section for displaying the facility identified by the search of said facility search section.

2. The point service utilizing system according to claim 1, wherein said search result displaying section is adapted to display detailed information about said facility when a predetermined operation is executed by a user.

3. The point service utilizing system according to claim 2, wherein said detailed information about the displayed facility includes the contents of a point service to be offered by said facility.

4. The point service utilizing system according to claim 2, wherein said detailed information about the displayed facility includes the contents of the point service which is available to the user within a range of said cumulative number of points owned by said user.

5. The point service utilizing system according to claim 1, further comprising:
a destination setting section for selecting and setting a destination for route search processing from among a plurality of the facilities displayed by said search result displaying section; and
a route search section for searching for a guidance route for a vehicle to the destination set by said destination setting section.

6. The point service utilizing system according to claim 5, further comprising a route guidance section for guiding the vehicle along the guidance route searched for by said route search section.

7. The point service utilizing system according to claim 1, further comprising a driving state detector for detecting a driving state of a vehicle of the user,
wherein said point managing section carries out addition processing of points corresponding to the vehicle driving state detected by said driving state detector to said cumulative number of points.

8. The point service utilizing system according to claim 7, wherein said driving state detector detects the driving state of the vehicle of interest in relation to another vehicle associated with the traveling of the vehicle of interest.

9. The point service utilizing system according to claim 8, wherein, if a driver of said vehicle of interest gives way to a driver of said other vehicle when said other vehicle is about to enter a road or lane where said vehicle of interest is traveling, said point managing section carries out addition processing of points to said cumulative number of points.

10. The point service utilizing system according to claim 8, wherein, if the driver of said vehicle of interest gives a higher priority to the traveling movement of said other vehicle when a future traveling movement of said vehicle of interest is identical to that of said other vehicle, said point managing section carries out addition processing of points to said cumulative number of points.

11. A method of utilizing a point service, comprising:
when a user is specified, obtaining the cumulative number of points corresponding to the specified user;
searching for an available facility based on said cumulative number of points; and
displaying the facility identified by the search.

12. The method of utilizing a point service according to claim 11, further comprising displaying detailed information on said facility identified by the search when a predetermined operation is executed by a user.

13. The method of utilizing a point service according to claim 12, wherein said detailed information on the facility includes the contents of the point service to be offered by said facility.

14. The method of utilizing a point service according to claim 11, further comprising:
selecting and setting a destination for route search processing from among a plurality of the facilities identified by the search; and
searching for a guidance route for the vehicle to said destination.

15. The method of utilizing a point service according to claim 14, further comprising guiding a vehicle along the guidance route.

16. A vehicle navigation apparatus comprising:
a point reader that when a user is specified, is adapted to read the cumulative number of points corresponding to the specified user from an external point managing section for managing the cumulative number of points owned by each user;
a facility search section for searching for an available facility based on said cumulative number of points read by said point reader; and
a search result displaying section for displaying the facility identified by the search of said facility search section.

17. The vehicle navigation apparatus according to claim 16, further comprising:
a destination setting section for selecting and setting a destination for route search processing from among a plurality of facilities displayed by said search result displaying section; and
a route search section for searching for a guidance route for the vehicle to the destination set by said destination setting section.

18. The vehicle navigation apparatus according to claim 16, wherein said search result displaying section is adapted to display detailed information on said facility when a predetermined operation is executed by a user.

19. The vehicle navigation apparatus according to claim 18, wherein said detailed information on the displayed facility includes the contents of a point service to be offered by said facility.

20. The vehicle navigation apparatus according to claim 18, wherein said detailed information on the displayed facility includes the contents of the point service which is available to the user within a range of said cumulative number of points owned by said user.
